(19) United States
(12) Patent Application Publication
(10) Pub. No.: US 2017/0026478 A1
(43) Pub. Date: Jan. 26, 2017

(54) METHOD AND APPARATUS FOR REDUCING USER DISTRACTION IN A GROUP SETTING

(71) Applicant: MOTOROLA SOLUTIONS, INC, SCHAUMBURG, IL (US)

(72) Inventor: ALAIN D ABBATE, TAMARAC, FL (US)

(21) Appl. No.: 14/805,156

(22) Filed: Jul. 21, 2015

(51) Int. Cl. H04L 29/08; G06F 3/14; G09G 5/30; H04L 12/24; G06K 9/00

(52) U.S. Cl. CPC H04L 67/22; H04L 41/0806; G06K 9/00335; G09G 5/30; G06K 9/00604; G06F 3/1423; G09G 2370/022; G09G 2354/00; G09G 2320/08; G09G 2320/0666; G09G 2370/025

(57) ABSTRACT

During operation a device will determine human members of a group, and then will monitor the group members to determine if at least N members of the group are paying attention to their surroundings (i.e., not distracted). If less than N members of the group are not distracted, a number of people within the group will have their devices prevent the viewing of content. So for example, if it is determined that at least five people within a group of 20 people need to be paying attention to their surroundings, and it is also determined that 17 people within the group are running applications on their devices that require the user's attention, then at least two currently-distracted people within the group will be prevented from viewing their device(s).

### RELATED APPLICATIONS

The present invention is related to U.S. patent application Ser. No. 14/638,288, entitled Method and Apparatus for Reducing User Distraction, filed Mar. 4, 2015.

### FIELD OF THE INVENTION

The present invention generally relates to reducing user distraction, and more particularly to a method and apparatus for reducing user distractions for group participants by allowing periodic viewing of devices within the group.

### BACKGROUND OF THE INVENTION

It is easy to focus on a mobile device or computer to the point where the device operator is unaware of his/her surroundings. However, even during dangerous situations, some level of distraction may be acceptable in a group situation where others within the group are not distracted. For example, in a group situation, where users are co-located (e.g., within 30 feet of each other) it may not be necessary for all members of the group to pay attention to the environment at the same time, as long as some members are paying attention. It would be beneficial if there existed a way to guarantee that a minimum number of users within a group were not distracted so that others may utilize various electronic devices. Therefore, a need exists for a method and apparatus for reducing user distraction in certain situations, while still allowing other users to view/access material on the device during those certain situations.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates a device displaying information.

FIG. 2 shows operation of the device of FIG. 1.

FIG. 3 shows operation of the device of FIG. 1.

FIG. 4 illustrates operation of a group of devices.

FIG. 5 is a block diagram of the device of FIG. 1.

FIG. 6 is a flow chart showing the operation of the device of FIG. 5.

FIG. 7 is a flow chart showing the operation of the device of FIG. 5.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In a group situation, where devices are co-located, a method and apparatus for reducing user distraction is provided herein. During operation a device will determine human members of a group, and then will monitor the group members to determine if at least N members of the group are paying attention to their surroundings (i.e., not distracted). If less than N members of the group are not distracted, a number of people within the group will have their devices prevent the viewing of content. So for example, if it is determined that at least five people within a group of 20 people need to be paying attention to their surroundings, and it is also determined that 17 people within the group are running applications on their devices that require the user's attention, then at least two currently-distracted people within the group will be prevented from viewing their device(s).

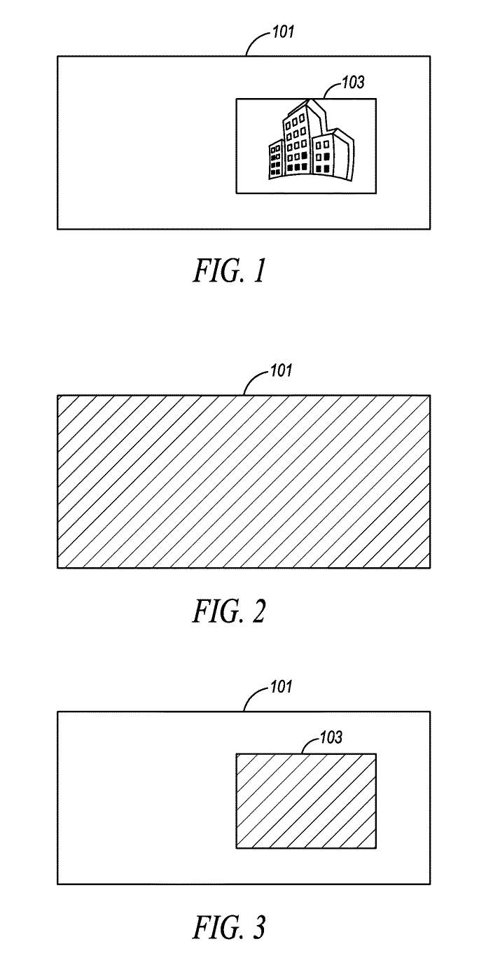

FIG. 1 shows a screen 101 of a user device. Screen 101 may be part of a computer, smart phone, police radio, police terminal, tablet computer, or any other portable or stationary device that displays information. Screen 101 displays visual output to the user. The visual output may include text, graphics, video, windows, and any combination thereof. Some or all of the visual output may correspond to currently-running applications.

As shown in FIG. 1, screen 101 displays content 103, which in this particular example comprises window 103, under the control of a particular application. For example, window 103 may show a video output of a security camera. Although one window is shown on touch screen 101, one of ordinary skill in the art will recognize that multiple windows may be simultaneously running on screen 101.

As discussed above, it is often the case where a minimum number of users within a group need to be aware of their surroundings. Not all users need to be prevented from viewing their device as long as a predetermined number of users (N) are paying attention to their surroundings. For example, a group of public-safety officers may be in a critical situation where staring at the video camera feed 103 for long periods of time will put the officers in a dangerous situation. In order to address this situation, content will be shown to certain members of the group, but not shown to other members of the group so that a minimum number of officers are forced to pay attention to their surroundings. This is accomplished by various devices preventing the viewing of content on the screen. A device may prevent further viewing of its screen by preferably turning off the screen, or making the screen opaque, or by making a window opaque. This is illustrated in FIG. 2 and/or FIG. 3. It should be noted that during periods where the device will prevent viewing, the device may also prevent input from the user via the touch screen. When it has been determined that a particular user's distraction does not need to be prevented, the devices associated with the user will allow full access without preventing the viewing of content (and accept input from the user).

A device may prevent viewing of content as shown in FIG. 3 by simply blacking out a particular window, or alternatively, the device may prevent viewing of content by blacking out the whole screen as shown in FIG. 2. In alternate embodiments of the present invention, where multiple windows exist on screen 101, only certain windows (deemed of lesser importance) may have their content hidden as shown above.

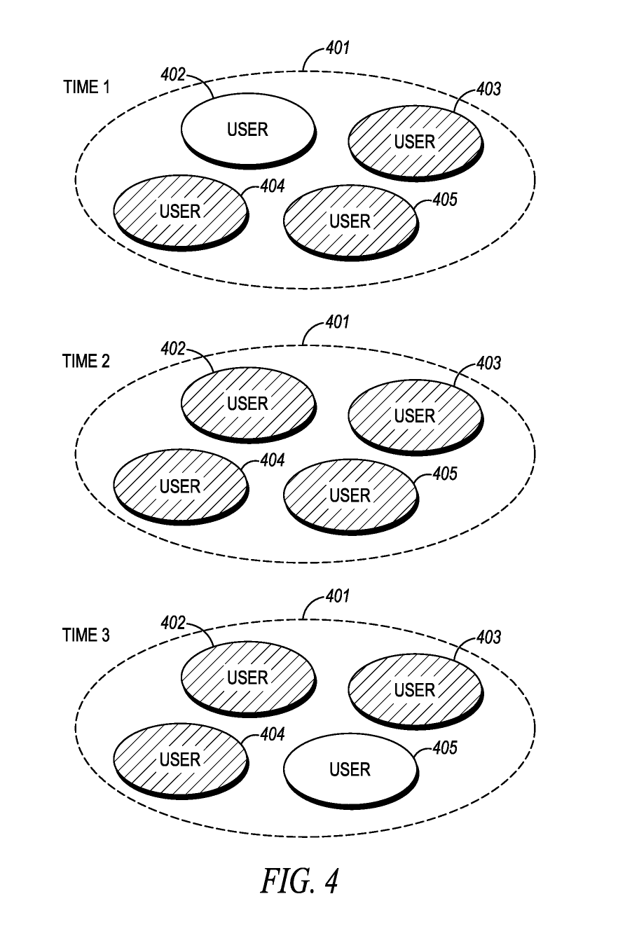

The above-described technique is illustrated in FIG. 4. As shown in FIG. 4, there are four users within group 401. At time 1, user 402 is paying attention to his/her surroundings and users 403-405 are not paying attention to their surroundings. It may be assumed that user 402 is paying attention to his/her surroundings because user 402 is not currently running any application (e.g., video) on at least one of his/her devices that causes them to stare at their display. In a similar manner, it may be assumed that users 403-405 are not paying attention to their surroundings because the current applications being run on their devices require the user's attention.

If a minimum number of group members that must pay attention to their surroundings is 1 (N=1), then users 403-405 may safely focus on their mobile devices. It should also be noted that the number of users that must pay attention may depend on context, so for example, in a dangerous context 2, 3 or even all 4 members may be forced to pay attention by preventing them from viewing their devices screen.

At time 2, no users are paying attention. After a minimum amount of time with no users paying attention (which may be zero), at least one member of the group must focus on their surroundings. At time 3, user 405 will be forced to pay attention by automatically shutting down display on the mobile devices used by user 405.

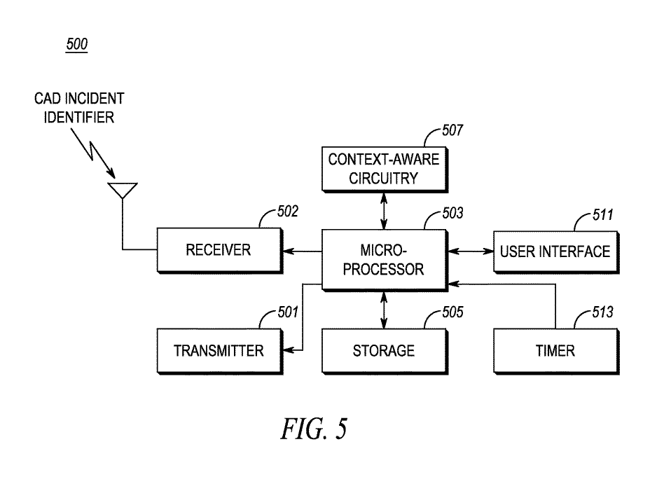

FIG. 5 is a block diagram of device 500 used to perform the above-mentioned technique. In a first embodiment of the present invention, device 500 is preferably a group-member device which forms a local-area network with other group-member devices. In alternate embodiments of the present invention, the functionality of device 500 may be offloaded to a server. In the first embodiment, devices may form a “group” by forming a Bluetooth® piconet and designating one device as a master device. Many techniques exits that “choose” a master device. For example, European Patent Application No. EP 2 672 762, entitled “Connecting the Highest Priority Bluetooth Device to a Device” automatically connects Bluetooth devices based on a priority level.

Although the elements of FIG. 5 can exist within a single device 500, in alternate embodiments of the present invention, these elements may exist separately as part of a “user space”. The user space can be defined as the user's personal space that includes all the electronic devices, communication devices, sensors and displays that a user would carry. These devices carried by the user typically communicate with each other using wired or wireless communication protocols. For example, a public safety official may carry one or more communications radios with their in-built individual displays and sensors such as a compass, gyroscope, accelerometer, holster detector, pedometer etc., wearable devices such as helmet cameras, wrist displays, head-mounted displays, body harness or jackets with in-built devices such as a lapel camera, sensors like temperature sensors, microphone, etc. In such a case, the components shown in FIG. 5 are distributed amongst many physical devices within a user space that communicate with each other using wired or wireless communications protocols such as Bluetooth, Near Field Communications, Wireless Local Area Network etc. In alternate embodiments, the user space extends to a user's vehicular space for example when the user is traveling in a vehicle and would additionally have access to the electronic devices, communications devices, displays and sensors in the vehicle via wired or wireless communications protocols such as Bluetooth, Near Field Communications, Wireless Local Area Network etc.

Device 500 preferably comprises processor 503 that is communicatively coupled with various system components, including display 101, receiver 502, general storage component 505, context-aware circuitry 507, timer 513, and potentially, a user interface (GUI) 511. Only a limited number of system elements are shown for ease of illustration; but additional such elements may be included in the device.

Processing device 503 may be partially implemented in hardware and, thereby, programmed with software or firmware logic or code for performing functionality described herein; and/or the processing device 503 may be completely implemented in hardware, for example, as a state machine or ASIC (application specific integrated circuit). Processing device 503 is configured to process the received information from various components in order to determine whether or not to block access to screen 101, and/or block access to screens located on other devices.

Storage 505 can include short-term and/or long-term storage of various information needed for determining whether or not to block access to any screen 101. For example, storage 505 may be populated with locations (for location-based blocking), a computer-aided-dispatch (CAD) incident database (for CAD incident-based blocking), device identification numbers and their associated user (e.g., MAC address/user association) . . . , etc. Storage 505 may be populated with device priorities, so that lower-priority devices have their screens blocked prior to higher-priority devices. Storage 505 may further store software or firmware for programming the processing device 503 with the logic or code needed to perform its functionality, including but not limited to the logic or code needed to determine when to block viewing of display 101.

User interface 511 includes display 101, and receives an input from the user which may be used to populate storage 505. User interface 511 may include a keypad, a display/monitor, a mouse/pointing means, and/or various other hardware components to provide a man/machine interface. In some embodiments, no user intervention will be needed to activate this invention on the said device.

Although context-aware circuitry 507 is shown as a single item, it is envisioned that circuitry 507 may comprise more than one logic circuitry (hardware or software) to determine various contexts simultaneously. For example, context-aware circuitry 507 may comprise one or more of an eye detector, a GPS receiver, a motion detector, and/or an accelerometer. Regardless of the makeup of context-aware circuitry 507, logic circuitry 503 will use information generated by circuitry 507 to determine whether or not to block viewing of screen 101.

Transmitter 501 and receiver 502 comprises common circuitry known in the art for communication utilizing a well known communication protocol, and serve as means for transmitting and receiving, for example, a CAD incident identifier from a dispatch center. Although only a single transmitter and receiver are shown, multiple transmitters and receivers may be present, each utilizing a different communication-system protocol. For example, transmitter 501 and receiver 502 may be well known long-range transceivers that utilize the Apco 25 (Project 25) communication system protocol. Other possible transmitters and receivers include any combination of the IEEE 802.11 communication system protocol, receivers utilizing Bluetooth, receivers utilizing HyperLAN protocols, or receivers utilizing any other communication system protocol including but not limited to a land mobile radio system (LMRS), a public land mobile radio, a private land mobile radio system, a first responders network authority (FirstNet) nationwide network (FNN), an enhanced data rates for Global System for Mobile Communication (GSM) Evolution (EDGE) Radio Access Network (GERAN), a Universal Terrestrial Radio Access Network (UTRAN) and/or an Evolved Universal Terrestrial Radio Access (E-UTRAN) as defined by the long term evolution (LTE), LTE-advance (LTE-A) and subsequently defined in subsequent releases, such as LTE-beyond (LTE-B), Near Field Communications, mesh networking etc.

Prior to describing operation of the device of FIG. 5, the following definitions aide in understanding the present invention:

Group of Devices—

Those devices that are within a predetermined distance from each other (e.g., 30 feet) and are networked and able to share data among the devices. For example, devices that form a piconet, local-area network, or body area network may be considered a group of devices.

Group of Users—

Any user associated with at least one device from the group of devices are considered to be part of a group of users. For example, there may be 12 networked devices within the group of devices. The 12 devices may be under the control of only three users, with each user associated with four devices. The three users are considered to be a group of users.

Determining a Group of Devices

Defining a group of devices may be as straight forward as simply pre-populating device IDs within storage 505. The pre-populated devices will be considered a group of devices. The pre-populated group members may be, for example, all devices belonging to a platoon of soldiers, or devices belonging to public-safety officers on a particular shift. In another embodiment of the present invention, the group of devices may be defined by logic circuitry 503 as those devices that are currently part of a piconet. For example, all devices that are currently in range, and have associated with a local-area network may be considered group members.

Determining a Group of Users

Regardless of how a group of devices is formed, database 505 comprises information that associates a particular user to a particular device within the group of devices. For example, three devices may be associated with a first user, while a single device may be associated with a second user. The group of users comprises all users that are associated with at least one device from the group of devices.

Determining Number of People N within the Group of M People that Need to Focus on Surrounding Environment

The number of users that cannot be distracted (N) within a group of users is preferably based on a current context for all members within the group of users. For example, assume that the group of users comprises M members. During certain critical situations it may be decided that everyone within the group will need to pay attention to their surroundings (N=M). There may be other, non-critical situations where N may be much less than M. There are multiple ways envisioned for determining N (number of users that should not be distracted from their surroundings). The discussion below is not meant to limit any particular technique for doing so. Additionally, multiple techniques may be simultaneously used. Some of the preferred techniques are described below.

Context-aware circuitry 507 may comprise a holster detector that determines when an officer has drawn their gun. During periods when the officer's gun is un-holstered, viewing of screens 101 may be limited as discussed above, with N=M.

Context-aware circuitry 507 may comprise a location detector that determines a current location of the device. For example, context-aware circuitry may comprise a GPS receiver. Unsafe locations may be stored in storage 505. At locations deemed unsafe, viewing of screens 101 may be limited as discussed above, with N<M, for example N=½(M).

An officer may be assigned to a particular incident. A CAD incident identifier may be received by receiver 502. An incident identification (sometimes referred to as an incident scene identifier, or a CAD incident identifier) is generated for incidents where the officer is dispatched. This ID could be something as simple as a number, or something as complicated as an identification that is a function of populated fields, one of which may comprise an incident type. Unsafe incident types may be stored in storage 505. While being assigned to incidents deemed unsafe, viewing of screens 101 may be limited as discussed above, with N being a function of a CAD incident identifier, e.g., N=f(CAD incident identifier).

Public safety radios typically have an emergency button. Thus, context-aware circuitry 507 may comprise an emergency button. Pressing any emergency button on the M devices may limit viewing of screens 101 as discussed above, with N=M.

Context-aware circuitry 507 may comprise bio-monitoring sensors that detect elevated heart rate, elevated breathing rate or other indications of a stressful or unsafe situation for any user of the M devices. When unsafe biological indications are detected, viewing of screens 101 may be limited as discussed above such that N is a function of any detected biomarker.

Determining when a User is Distracted

In a preferred embodiment of the present invention it is assumed that a user is distracted when the user has a high probability that they are currently viewing a screen on one of their associated devices. With this in mind, context-aware circuitry 507 may comprise standard eye-detection circuitry as is commonly known in the art. This circuitry can be used to determine when the user is viewing screen 101. This information will be passed to the master device of the piconet.

In an alternate embodiment, context-aware circuitry 507 may comprise an accelerometer that is used to determine if a user is viewing screen 101. Accelerations may be used to determine if the user is viewing screen 101. For example, a screen angled away from user's view may indicate a user is not viewing screen 101. Similarly, a lowered screen may indicate a user is not viewing screen 101. This information (e.g., an accelerometer reading) may be passed to the master device.

In an alternate embodiment, context-aware circuitry 507 may comprise an application-monitoring function (software) to determine if a device is currently running any applications that are determined to require a user's attention. Thus, an identity of a currently-running application may be used to determine if the user is viewing screen 101. For example, if a video application is currently running, and providing video to a user, it may be assumed that the user is viewing the screen. Again, this information may be passed to the master device.

Context-aware circuitry 507 functioning as application monitoring software may additionally determine if a user is currently inputting data, for example, inputting text. This may be used to determine if a user is distracted.

Restricting Viewing

Processor 503 may be configured to restrict viewing of screen 101 by instructing screen 101 to block viewing of a particular window displayed on screen 101 (as shown in FIG. 3). In response to the instructions, screen 101 may make opaque a particular window as described above. Additionally, processor 503 may be configured to restrict viewing of screen 101 by instructing screen 101 to block complete viewing of screen 101 (as shown in FIG. 2). In response to the instructions, screen 101 may make itself opaque.

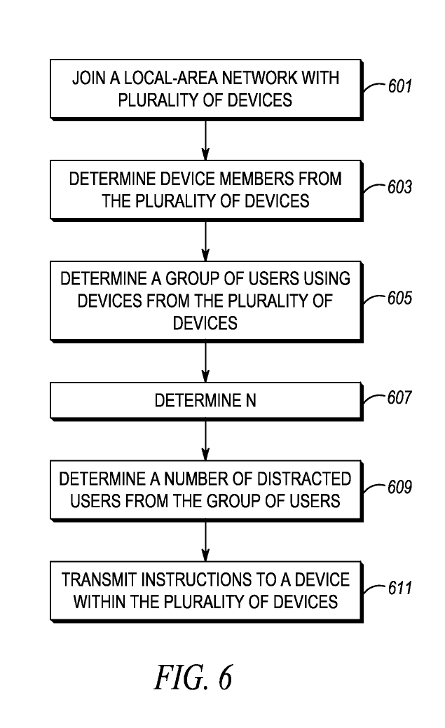

FIG. 6 is a flow chart showing the operation of the device of FIG. 5 when acting as a master device. More particularly, FIG. 6 is a flow chart showing those steps (not all are necessary) taken by a master device for reducing user distraction as described above. The logic flow begins at step 601 with logic circuitry 503 joining a local-area network with plurality of devices. As discussed above, the plurality of devices are preferably co-located devices, within, for example, 100 feet of each other. At step 603 logic circuitry 503 determines device members from the plurality of devices. This step comprises logic circuitry determining device IDs from the plurality of devices forming the local-area network. From the device IDs, logic circuitry 503 determines a group of users using devices from the plurality of devices (step 605). A number a number (N) of allowed distracted users is determined by logic circuitry at step 607 and a number of distracted users from the group of users is determined by logic circuitry at step 609. Finally, at step 611 logic circuitry 503 instructs transmitter 501 to transmit instructions to a device within the plurality of devices, wherein the instructions prevent viewing of a screen on the device. As discussed, the determination to transmit the instructions is based on the number of distracted users and N.

As discussed above, storage 505 is provided, and logic circuitry 503 may determine the group of users by utilizing the database to associate users to devices from the plurality of devices (by utilizing stored device ID/user associations).

Additionally, Context-aware circuitry 507 is provided, with the logic circuitry 503 determining N by utilizing context-aware circuitry 507 to determine a current context. For example, context-aware circuitry may comprise location-finding circuitry that determines a current location for device 500. N may be based on location, with dangerous locations having a higher value for N than safer locations. For example, areas with higher crime rates may have a higher value of N than areas with lower crime rates.

As discussed above, receiver 502 is provided, with logic circuitry 503 determining if a user is distracted by receiving, via a receiver, information from devices from the plurality of devices. This information may comprise a currently-running application, a location of a user's eyes, or an orientation of a device.

Optional timer 513 may be provided in order to allow a predetermined amount of time with distracted users exceeding the limit. For example, if N=5, and there are currently 4 non-distracted users, logic circuitry may use timer 513 to count down (e.g., 10 seconds) prior to proceeding to prevent viewing. The step of transmitting instructions to a device to prevent viewing of a screen on the device may thus occur after a predetermined amount of time.

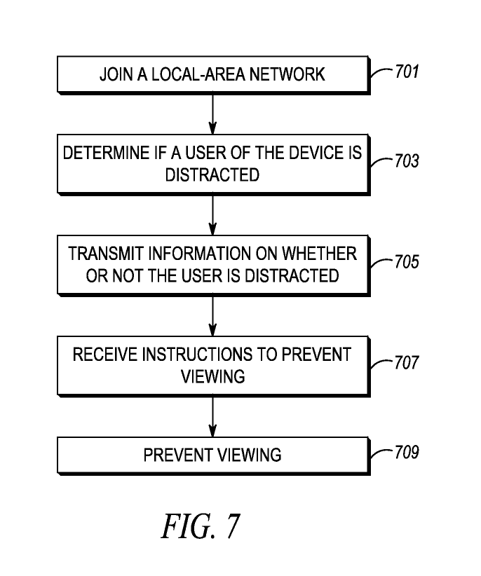

FIG. 7 is a flow chart showing the operation of the device of FIG. 5 when acting as a slave device within the piconet or local-area network. The logic flow begins at step 701 where logic circuitry 503 joins a local-area network that comprises a plurality of devices. At step 703 logic circuitry 503 determines if a user of the device is distracted, and uses transmitter 502 to report (over the LAN) to a master device, information on whether or not the user is distracted (step 705). Receiver 502 receives instructions over the local-area network from the master device, wherein the instructions cause the device to prevent viewing a screen on the device (step 707). The instructions are passed to logic circuitry 503 where logic circuitry 503 prevents viewing of screen 511 on device 500 (step 709).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

It should also be noted that the above description was written in the context of limiting a user's access to viewing a screen during situations where the user should not be distracted, however, one of ordinary skill in the art will recognize that the above text is not meant to limit viewing as described above to any particular environment. So, for example, if any situation exists where a screen should be limited as discussed above, the following claims are intended to cover those situations.

In another example, extremely important information should be shown to the user, even if the time limit for normal viewing of the screen has been reached. For example a CAD query indicates that a suspect has an outstanding arrest warrant. Those skilled in the art will further recognize that references to specific implementation embodiments such as “circuitry” may equally be accomplished via either on general purpose computing apparatus (e.g., CPU) or specialized processing apparatus (e.g., DSP), both executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for reducing user distraction, the method comprising the steps of:
joining a local-area network with a plurality of devices;
determining by logic circuitry, device members from the plurality of devices;
determining via the logic circuitry, a group of users using devices from the plurality of devices;
determining via the logic circuitry, a number (N) of allowed distracted users;
determining via the logic circuitry, a number of distracted users from the group of users; and
transmitting instructions to a device within the plurality of devices, wherein the instructions prevent viewing of a screen on the device, and wherein the step of transmitting is based on the determination of the number of distracted users from the group of users, and additionally based on N.

2. The method of claim 1 wherein the step of determining the group of users comprises the step of utilizing a database to associate users to devices from the plurality of devices.

3. The method of claim 1 wherein the step of determining N comprises the step of utilizing context-aware circuitry to determine a current context, and wherein N is based on the current context.

4. The method of claim 1 wherein the step of determining N comprises the step of utilizing location-finding circuitry to determine a current location, and wherein N is based on the current location.

5. The method of claim 1 wherein the step of determining the number of distracted users comprises the step of receiving, via a receiver, information from devices from the plurality of devices, wherein the information comprises information used to determine whether or not a user is distracted.

6. The method of claim 5 wherein the information comprises a currently-running application.

7. The method of claim 5 wherein the information comprises information taken from the group consisting of an accelerometer reading, and a location of a user's eyes.

8. The method of claim 1 wherein the instructions prevent viewing by making the screen opaque.

9. The method of claim 1 wherein the instructions prevent viewing by making a window on the screen opaque.

10. A method comprising the steps of:
joining, by a device, a local-area network that comprises a plurality of devices;
determining if a user of the device is distracted;
reporting to a master device, information on whether or not the user is distracted, wherein the reporting takes place over the local-area network;
receiving instructions over the local-area network from the master device, wherein the instructions cause the device to prevent viewing a screen on the device; and
preventing viewing of the screen on the device.

11. The method of claim 10 wherein the step of determining if the user is distracted comprises the step of using an accelerometer to determine if the user is distracted based on an orientation of the device.

12. The method of claim 10 wherein the step of determining if the user is distracted comprises the step of monitoring applications currently being run by the device to determine if the user is distracted based on the applications currently being run.

13. An apparatus comprising:
logic circuitry configured to join a local-area network among a plurality of devices, determine device members from the plurality of devices, determine a group of users using devices from the plurality of devices, determine a number (N) is allowed distracted users, determine a number of distracted users from the group of users; and
a transmitter configured to transmit instructions to a device within the plurality of devices, wherein the instructions prevent viewing of a screen on the device, and wherein the transmitter transmits the instructions based on N and the number of distracted users from the group of users.

14. The apparatus of claim 13 further comprising:
a database, wherein logic circuitry is configured to determine the group of users by utilizing the database to associate users to devices from the plurality of devices.

15. The apparatus of claim 14 further comprising:
context-aware circuitry, wherein the logic circuitry is configured to determine N by utilizing the context-aware circuitry to determine a current context, and wherein N is based on the current context.
